(19) United States
(12) Patent Application Publication
(10) Pub. No.: US 2010/0092106 A1
(43) Pub. Date: Apr. 15, 2010

(54) QUASI-QUADRATIC INTERPOLATION OF IMAGE DATA

(76) Inventor: WAYNE SIMON, Evergreen, CO (US)

Correspondence Address: MARSH, FISCHMANN & BREYFOGLE LLP, 8055 East Tufts Avenue, Suite 450, Denver, CO, 80237, US

(21) Appl. No.: 12/250,375

(22) Filed: Oct. 13, 2008

(51) Int. Cl. G06K 9/32

(52) U.S. Cl. 382/300

(57) ABSTRACT

The presented systems and methods are directed towards processing of image data. Various aspects are directed towards sharpening digital images while other aspects are directed towards interpolating and/or upsampling image data. The utilities have particular application to digital image processing. However, it will be appreciated that aspects of the present invention may be utilized with any pixel imaging application including seismic imaging.

### FIELD OF INVENTION

The present invention relates to interpolation of pixel data for imaging applications. In one arrangement, the present invention relates to a quadratic interpolation method that allows for determining intermediate points in a digital image while maintaining higher order derivatives in both the x and y directions.

### BACKGROUND OF THE INVENTION

Interpolation is a method of constructing new data points within the range of a discrete set of known data points. There are a number of ways to interpolate data sets. Most interpolation methods involve fitting a function to the known data set and evaluating that function at the desired point. One form of interpolation for a desired data point is linear interpolation where a line is fit between two adjacent data points. The equation of the line may then be solved for the desired sample point. Such linear interpolation is quick and easy, but it is not very precise. Other interpolation methods, including polynomial interpolation tend to produce smoother interpolants. Further, unlike linear interpolation, a number of other interpolation methods are continuous functions over a data set providing improved precision.

In some interpolation applications, however, simple continuity of the interpolated function is not adequate. For example, if a wall reflects a wave, the first derivative of the wall surface is needed for the direction of the wave, and the second derivative is required for the focus of the wave. A second example is the problem of finding the minimum of a surface represented by a set of discrete points. In order to efficiently find the minimum, the first and second derivatives of the surface must be used to determine the step direction and distance to the minimum. Accordingly, it is desirable in many instances to have an interpolation scheme that allows for maintaining continuity through the second derivative.

One application where maintaining continuity through the second derivative is desirable is processing digital images (e.g., pixel data) One particular application is upsampling/increasing the number of pixels in an image to improve its appearance (e.g., smooth the image by removing or reducing the pixilation effects). This requires 2-D interpolation, preferably where the higher order derivatives are all continuous in both directions.

There are a number of interpolation methods for processing digital pictures. One common high-resolution interpolation method is the bicubic method where each pixel output by the bicubic algorithm is a result computed from sixteen (4×4) pixels of the original picture. While providing good results, the bicubic method is computationally intensive and is not reversible. That is, once image data is interpolated, the original data cannot be restored without accessing another copy of the original data.

### SUMMARY OF THE INVENTION

The present system and methods (i.e., utilities) are directed towards processing of image data. Various aspects of the utilities are directed towards sharpening the images, and other aspects are directed towards interpolating and/or upsampling image data. The utilities have particular application to digital image processing. However, it will be appreciated that aspects of the present invention may be utilized with any pixel imaging application including, without limitation, digital picture imaging and seismic imaging.

In a first aspect, a utility is provided for improving the contrast of a digital image. The utility includes obtaining a pixel image that includes a plurality of pixel values for corresponding pixel areas of the image. Initially, these pixel values are average values over the corresponding pixel areas. The present aspect converts these average values into point values centered at the center of each pixel area. In order to make such conversion, four adjacent pixel values to a subject pixel area are identified to estimate a two-dimensional quadratic representation over the pixel area. This two-dimensional quadratic representation is integrated to obtain a correction formula for the subject pixel value. Importantly, this integration over the subject pixel area is constrained to be equal to the measured value of the subject pixel. This correction formula is then utilized to calculate a point value for the subject pixel that is centered at the center of the subject pixel. Such processing allows for sharpening the image and/or improving contrast between adjacent pixels while maintaining the overall intensity between and original image and a point value image. Accordingly, this aspect may be utilized with subsequent aspects disclosed herein in order to provide improved processing of digital images.

According to another aspect, an interpolation method for upsampling digital images is provided. Initially, a pixel image is obtained that includes a plurality of pixels. For an area defined by four of the pixels, four quadratic surfaces are calculated (e.g., at the corners of the area). Using these four quadratic surfaces, a quasi-quadratic surface is generated that is a function of the four quadratic surfaces. The quasi-quadratic surface is then utilized to determine an interpolated value for a point within the area. Accordingly, such interpolation may be performed at multiple points within the digital image. In any case, the interpolated value(s) are utilized to generate an interpolated pixel image. The present utility allows for upsampling any desired number of subpixels for each pixel within the image. Further, the utility preserves the values of the original pixels such that the process may be reversed without altering the original image.

In one arrangement, each of the quadratic surfaces is calculated from a pixel set that includes the four pixels that define the area in which a point is being interpolated. In this regard, each of the four quadratic surfaces may be continuous in first and second derivatives at these points as they share these common points. As may be appreciated, this may result in a smoother interpolated pixel image. In a further arrangement, the quasi-quadratic surface is defined as a function of a weighted sum of 12 pixels surrounding the area. In this regard, once weighting coefficients are determined for the pixel image, calculation of the subpixel values (i.e., interpolated values) is simplified thereby reducing the computational requirements of the utility.

In a further arrangement, the sum of the upsampled pixels is equal to the measured value of the original pixels within the image. In one arrangement, the pixel image including a plurality of pixels includes a plurality of values that are averages over the area of the pixels. Accordingly, the utility may further include converting values of the pixels to point values located at the centers of the pixels. As will be appreciated, this may improve the recognition of objects within the pixel image that are only a few pixels in diameter.

### BRIEF DESCRIPTION OF THE DRAWINGS

FIG. 1 illustrates a pixel image.

FIG. 2 illustrates a subject pixel and its nearest neighboring pixels.

FIG. 3 illustrates a pixel point image. (Top right should read Z_{i+1,j+1})

FIG. 4A illustrates an area bounded by pixel point images.

FIG. 4B illustrates pixel point values utilized in a quadratic equation.

FIG. 5 illustrates pixel point values used in an upsampling process.

FIG. 6 illustrates an original pixel upsampled into sub-pixels.

FIGS. 7A and 7B illustrate seismic data acquisition.

FIG. 8 illustrates a seismic data model.

FIG. 9 illustrates a pixel image formed from seismic data using the interpolation process of the present invention.

FIG. 10 illustrates a pixel image formed from seismic data without using the interpolation process of the present invention.

### DETAILED DESCRIPTION

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope of the invention as defined by the claims. For instance, while in certain implementations as described below, the present invention is applied digital picture images (e.g., pixel data), aspect of the invention may be applied to other fields such as seismic signals for generating subterranean images. Other applications are anticipated and considered within the scope of the present invention.

The systems and processes described herein may be performed on any appropriate computer system. Such a computer system may run application software and computer programs which can be used to perform the interpolation processes described herein. The software may be originally provided on computer-readable media, such as compact disks (CDs), magnetic tape, or other mass storage medium. Alternatively, the software may be downloaded from electronic links. The software is typically installed onto a computer system hard drive and/or electronic memory, and is accessed and controlled by the computer's operating system. Software updates may also be electronically available on mass storage media or downloadable from a host or vendor website. The software, as provided on the computer-readable media or downloaded from electronic links, represents a computer program product usable with a programmable computer processor having computer-readable program code embodied therein. The software contains one or more programming modules, subroutines, computer links, and compilations of executable code, which perform the functions of the interpolation process. The user interacts with the software via keyboard, mouse, voice recognition, and other user-interface devices (e.g., user I/O devices) connected to the computer system.

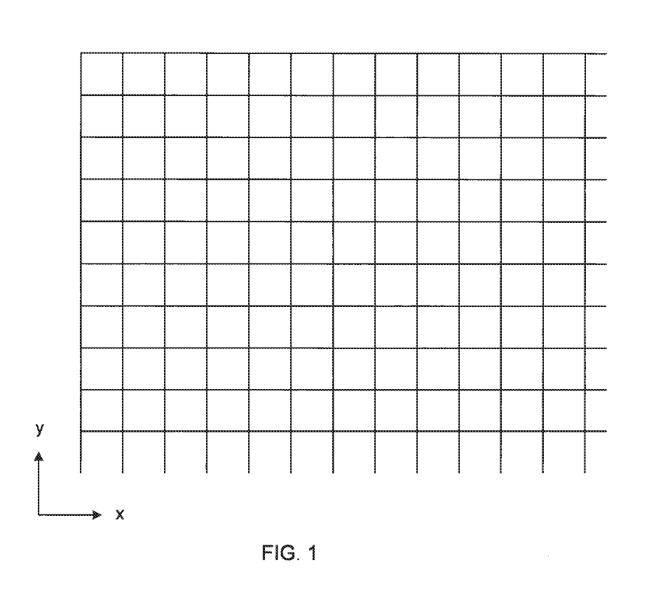

FIG. 1 illustrates a digital image (i.e., image data) that is composed of individual pixels, which are two-dimensionally arranged in a rectangular array. In the following descriptions, it is assumed that the x direction and the y direction are set as illustrated in FIG. 1. It will be appreciated that each pixel in the resultant grid represents a measured value of the radiance impinging on a sensor element. Often, it is desirable to enhance the resolution of such a digital image by upsampling the image. That is, it may be desirable to increase the number of pixels in the image to improve its appearance (e.g., smooth the image by removing or reducing the pixilation effects).

The current process recognizes that one of the difficulties with interpolating pixel images and their equivalents is that a pixel value is the average of the radiance impinging on that element of the sensor. If simple interpolation is used to approximate subpixel values, the average value over the original pixel area in the interpolated image is not always equal to the value of the original pixel. Peak pixels are under represented and valley pixels are over represented. That is, averaging destroys high frequency spatial information. This averaging reduces the contrast in the images. The limit of averaging, a single average of the whole image, has zero contrast. Further, upsampling such images may further reduce the contrast in the uspampled/interpolated image.

Upsampling increases the apparent resolution of an image by interpolation but does not recreate the information at high spatial frequencies, which was destroyed by the averaging of the sensor. The present method utilizes the knowledge that pixel values are measured averages to create a smooth representation of the measured image. Note that linear interpolation gives a continuous function, but first derivatives are discontinuous at every pixel. The upsampled image has many sharp points, which is not consistent with our knowledge of the nature of images. Many previous methods for interpolating such image data have been computationally intensive, not been continuous in multiple dimensions and have resulted in the corruption of the original image data. Use of the quasi-quadratic interpolation scheme described herein allows for providing improved resolution of digital images in two dimensions while maintaining the ability to revert to the original image data image. The quasi-quadratic surface provided herein is also continuous in the function and its first derivatives, and is nearly continuous in the second derivatives. A detailed outline of the quasi-quadratic scheme is provided below.

Prior to constructing the quasi-quadratic surface, it may be desirable to enhance the contrast of the image. In the present embodiment, translating the pixel values of the image to point values to define a point value image does this.

### Point Value Image

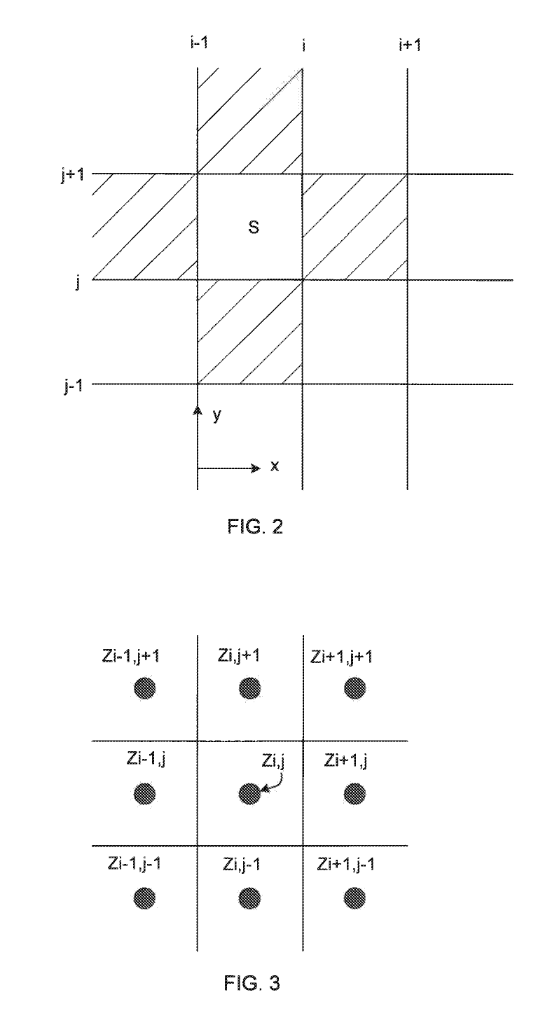

While the averaging destroys the high frequency spatial information, the knowledge that the pixel value is an average can be used to construct a point function whose integral over the area of the pixel does equal the value of the pixel. As illustrated in FIG. 2, the four nearest pixels (shown in cross hatch) to a subject pixel ‘S’ can be used to estimate a two dimensional quadratic representation over the area of the subject pixel ‘S’ (where S=pixel ij). The integral of this function over the area of the pixel gives a formula for the correction of the measured pixel value to a point value ‘Z’ at the center of the pixel. See FIG. 3. This may be repeated for all or most of the pixels in the image. A quasi-quadratic representation of the new point value image can then be used to construct a point value image for any desired upsampling.

A general quadratic surface can be written:

z(x,y)=a+bx+cx²+dy+ey²+fxy (1)

The only terms which contribute to a difference between the average value over the area of a pixel and the point value at the center of a pixel are the quadratic terms in x and y (coefficients c and e). These coefficients may be approximated using the measured values of the subject pixel and its four nearest neighbors.

$$\begin{matrix}c = \frac{\overline{{z}_{i + 1 , j}} - \overline{2 {z}_{i , j}} + \overline{{z}_{i - 1 , j}}}{2 {( Δ x )}^{2}} & ( 2 ) \\ e = \frac{\overline{{z}_{i , j + 1}} - \overline{2 {z}_{i , j}} + \overline{{z}_{i , j - 1}}}{2 {( Δ y )}^{2}} & ( 3 )\end{matrix}$$

Where: z̅_̅{̅i̅,̅j̅}̅=pixel value at xᵢ and yⱼ
Δx=uniform pixel spacing in the x direction
Δy=uniform pixel spacing in the y direction (usually equal to Δy)

### Then

$$( \frac{1}{Δ x Δ y} ) {\int }_{{x}_{1} - Δ x / 2 }^{x i + Δ x / 2 } {\int }_{{y}_{j} - Δ x / 2}^{{y}_{j} + Δ y / 2} z ( x , y ) d x d y = a + {bx}_{i} + {cx}_{i}^{2} + {dy}_{j} + {ey}_{j}^{2} + {fx}_{i} {y}_{j} + \frac{c}{3} {( \frac{Δ x}{2} )}^{2} + \frac{e}{3} {( \frac{Δ y}{2} )}^{2} \qquad ( 4 )$$

Where: x=horizontal dimension of an image (integral values of x are centers of pixels)
y=vertical dimension of image (integral values of x are centers of pixels)

Then

$${z}_{i , j} = \overline{{z}_{i , j}} - \frac{c}{3} {( \frac{Δ x}{2} )}^{2} - \frac{e}{3} {( \frac{Δ y}{2} )}^{2} \qquad ( 5 )$$

Where z_{i,j}=point value at center of pixel
z̅_̅{̅i̅,̅j̅}̅=average value over pixel area (measured pixel value)
   Note that in the computation of c and e, the measured values are used as if they were point values. In this regard, it may be beneficial to repeat the process using the computed point values. In any case, computation of c and e provides calculation in two dimensions (i.e. x and y). Once this is process is completed, new pixel image has been computed with point values ‘Zᵢⱼ’ at the center of each pixel as shown in FIG. 3. This process increases the gradient contrast between each point value while maintaining the original measured values of the pixels.

### Quasi-Quadratic Upsampling

A quasi-quadratic surface can be defined for the area of the point value image defined by:

xᵢ≦x≦xᵢ₊₁ and yⱼ≦y≦yⱼ₊₁

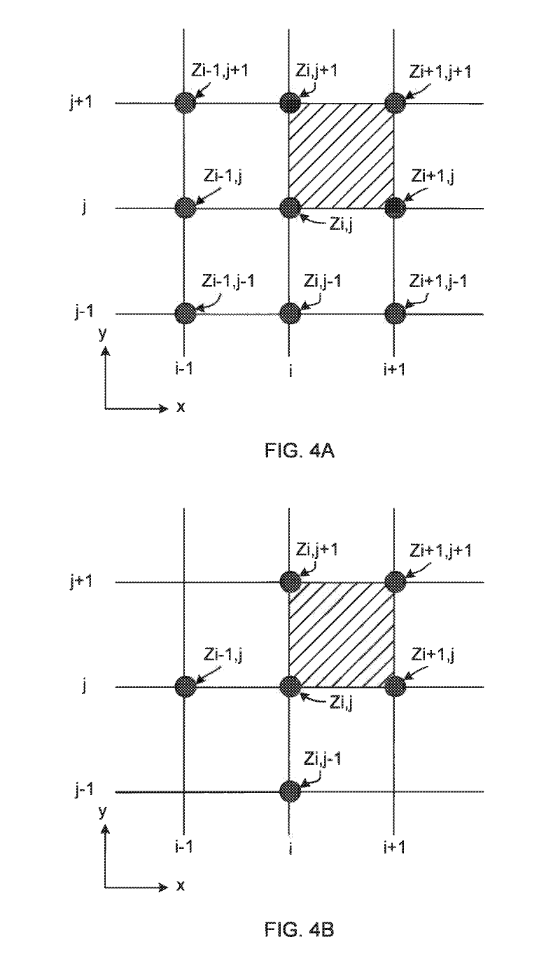

This is illustrated by the shaded region of FIG. 4A. This surface is constructed from four quadratic surfaces centered on the pixels Zᵢⱼ, Zᵢ₊₁ⱼ, Zᵢ₊₁ⱼ₋₁ and Zᵢⱼ₊₁ at the corners of the area. It is appropriate that each quadratic surface pass through the pixel centers of the four corners of this area. A point and its four nearest neighbors, plus the fourth corner pixel (ie., diagonal), satisfies this criteria. See FIG. 4B. The coefficients a through f are redefined for use with the non-dimensional variables uᵢ and vⱼ on the new image.

Then

$$\begin{matrix} {a}_{i , j} = {z}_{i , j} & ( 6 ) \\ {b}_{i , j} = \frac{{z}_{i + 1 , j} - {z}_{i - 1 , j}}{2} & ( 7 ) \\ {c}_{i , j} = \frac{{z}_{i + 1 , j} - 2 \cdot {z}_{i , j} + {z}_{i - 1 , j}}{2} & ( 8 ) \\ {d}_{i , j} = \frac{{z}_{i , j + 1} - {z}_{i , j - 1}}{2} & ( 9 ) \\ {e}_{i , j} = \frac{{z}_{i , j + 1} - 2 \cdot {z}_{i , j} + {z}_{i , j - 1}}{2} & ( 10 ) \\ {f}_{i , j} = {z}_{i + 1 , j + 1} + {z}_{i , j} - {z}_{i + 1 , j} - {z}_{i , j + 1} & ( 11 ) \\ {F}_{i , j} ( {u}_{i} , {v}_{j} ) = {a}_{i , j} + {b}_{i , j} \cdot {u}_{i} + {c}_{i , j} \cdot {u}_{i}^{2} + {d}_{i , j} \cdot {v}_{j} + {e}_{i , j} \cdot {v}_{j}^{2} + {f}_{i , j} \cdot {u}_{i} {v}_{j} & ( 12 )\end{matrix}$$

Where F_{i,j}(uᵢ, vⱼ)=the quadratic surface in the neighborhood of xᵢ and yⱼ

$$\begin{matrix}{u}_{i} = \frac{x - {x}_{i}}{Δ x} \\ = continuous variable , 0 \leq {u}_{i} \leq 1\end{matrix}$$

$$\begin{matrix}{v}_{j} = \frac{y - {y}_{j}}{Δ y} \\ = continuous variable , 0 \leq {v}_{j} \leq 1\end{matrix}$$

The other three quadratic surfaces are similar, with an appropriate shift in subscripts, except for the coefficient which must be determined by the fourth corner of the area. Since the cross derivative coefficient f, is being determined by the same area for all four quadratics, it might be expected that is should be the same value for all four quadratics. Algebra confirms that all the f coefficients are identical, with out a shift of subscripts.

f_{i+1,j}=f_{i,j+1}=f_{i+1,j+1}=f_{i,j} (13)

Now a quasi-quadratic function can be defined for the area,

i·Δx≦x≦(i+1)·Δx and j·Δy≦y≦(j+1)·Δy:

$${Q}_{i , j} ( {u}_{i} , {v}_{j} ) = {F}_{i , j} ( {u}_{i} , {v}_{j} ) \cdot {cos}^{2} ( \frac{π}{2} {u}_{i} ) \cdot {cos}^{2} ( \frac{π}{2} {v}_{j} ) + {F}_{i + 1 , j} ( ( {u}_{i} - 1 ) , {v}_{j} ) \cdot {sin}^{2} ( \frac{π}{2} {u}_{i} ) \cdot {cos}^{2} ( \frac{π}{2} {v}_{j} ) + {F}_{i , j + 1} ( {u}_{i} , ( {v}_{j} - 1 ) ) \cdot {cos}^{2} ( \frac{π}{2} {u}_{i} ) \cdot {sin}^{2} ( \frac{π}{2} {v}_{j} ) + {F}_{i + 1 , j + 1} ( ( {u}_{i} - 1 ) , ( {v}_{j} - 1 ) ) \cdot {sin}^{2} ( \frac{π}{2} {u}_{i} ) \cdot {sin}^{2} ( \frac{π}{2} {v}_{j} ) \qquad ( 14 )$$

### Where:

$$i = integer part of \frac{x}{Δ x}$$

$$j = integer part of \frac{y}{Δ y}$$

Note that uᵢ−1=uᵢ₊₁ and vⱼ−1=vⱼ₊₁, so Equation (12) could be expressed in terms of uᵢ and vⱼ. Q_{i,j} is analytic over its regions, so smoothness need only be examined at the two boundaries, uᵢ=0 and vⱼ=0. Evaluating Equation (14) at uᵢ=0, we obtain:

$${Q}_{i , j} ( 0 , {v}_{j} ) = {F}_{i , j} ( 0 , {v}_{j} ) \cdot {cos}^{2} ( \frac{π}{2} {v}_{j} ) + {F}_{i , j + 1} ( 0 , ( {v}_{j} - 1 ) \cdot {sin}^{2} ( \frac{π}{2} {v}_{j} ) \qquad ( 15 )$$

Equation (14) can be rewritten for the adjacent area by changing subscripts.

$${Q}_{i - 1 , j} ( {u}_{i - 1} , {v}_{j} ) = {F}_{i - 1 , j} ( {u}_{i - 1 ,} {v}_{j} ) \cdot {cos}^{2} ( \frac{π}{2} {u}_{i - 1} ) \cdot {cos}^{2} ( \frac{π}{2} {v}_{j} ) + {F}_{i , j} ( ( {u}_{i - 1} - 1 ) , {v}_{j} ) \cdot {sin}^{2} ( \frac{π}{2} {u}_{i - 1} ) \cdot {cos}^{2} ( \frac{π}{2} {v}_{j} ) + {F}_{i - 1 , j + 1} ( {u}_{i - 1} , ( {v}_{j} - 1 ) ) \cdot {cos}^{2} ( \frac{π}{2} {u}_{i - 1} ) \cdot {sin}^{2} ( \frac{π}{2} {v}_{j} ) + {F}_{i , j + 1} ( ( {u}_{i - 1} - 1 ) , ( {v}_{j} - 1 ) ) \cdot {sin}^{2} ( \frac{π}{2} {u}_{i - 1} ) \cdot {sin}^{2} ( \frac{π}{2} {v}_{j} ) \qquad ( 16 )$$

The common boundary with Q_{i,j} occurs at uᵢ₋₁=1.
Note that cos²

$$( \frac{π}{2} {u}_{i - 1} ) = {sin}^{2} ( \frac{π}{2} {u}_{i} ) ,$$

and vice versa. Then

$${Q}_{i - 1 , j} ( 1 , {v}_{j} ) = {F}_{i , j} ( 0 , {v}_{j} ) \cdot {cos}^{2} ( \frac{π}{2} {v}_{j} ) + {F}_{i , j + 1} ( 0 , {v}_{j} - 1 ) ) \cdot {sin}^{2} ( \frac{π}{2} {v}_{j} ) \qquad ( 17 )$$

Equations similar to (15) and (17) may be derived for evaluation across the vj=0 boundary, so Q(x,y) is continuous everywhere. The continuity of the first derivatives are established in a similar manner, simply by noting that first derivatives of the trigonometric terms are zero on every boundary. Establishing the characteristic of the second derivatives requires some manipulation. Written in somewhat abbreviated form, the second derivative is:

$$\frac{{\partial }^{2} {Q}_{i , j} ( {u}_{i} , {v}_{j} )}{\partial {u}_{i}^{2}} = \frac{{\partial }^{2} {F}_{i , j} ( {u}_{i} , {v}_{j} )}{\partial {u}_{i}^{2}} \cdot {cos}^{2} ( \frac{π}{2} {u}_{i} ) \cdot {cos}^{2} ( \frac{π}{2} {v}_{j} ) + + 2 \cdot \frac{\partial {F}_{i , j} ( {u}_{i} , {v}_{j} )}{\partial {u}_{i}} \cdot ( - π ) \cdot cos ( \frac{π}{2} {u}_{i} ) \cdot sin ( \frac{π}{2} {u}_{1} ) \cdot {cos}^{2} ( \frac{π}{2} {v}_{j} ) + + {F}_{i , j} ( {u}_{i} , {v}_{j} ) \cdot ( - {π}^{2} ) \cdot cos ( π {u}_{i} ) \cdot {cos}^{2} ( \frac{π}{2} {v}_{j} ) + {F}_{i + 1 , j} ( ( {u}_{i} - 1 ) , {v}_{j} ) \cdot ( {π}^{2} ) \cdot cos ( π {u}_{i} ) \cdot {cos}^{2} ( \frac{π}{2} {v}_{j} ) + {F}_{i , j + 1} ( {u}_{i} , ( {v}_{j} - 1 ) ) \cdot ( - {π}^{2} ) \cdot cos ( π {u}_{i} ) \cdot {sin}^{2} ( \frac{π}{2} {v}_{j} ) + {F}_{i + 1 , j + 1} ( ( {u}_{i} - 1 ) , ( {v}_{j} - 1 ) ) \cdot ( {π}^{2} ) \cdot cos ( π {u}_{i} ) \cdot {sin}^{2} ( \frac{π}{2} {v}_{j} ) \qquad ( 18 )$$

Now observe that the first set of terms will be identical across the boundary at ui=0, with the same argument as for continuity of the functions. The second set of terms will all be zero on any boundary with the same argument as for the continuity of the first derivatives. Finally, the last four terms will sum to zero for v,=0 or 1, since all four quadratics pass through the values at the corner of the area (by construction). Further, along the boundary, the error in the continuity of the second derivative is proportional to the difference between two quadratic surfaces, which have four points in common. Thus the second derivatives are continuous at the corners, but, in general, may have small errors in continuity along the boundaries.

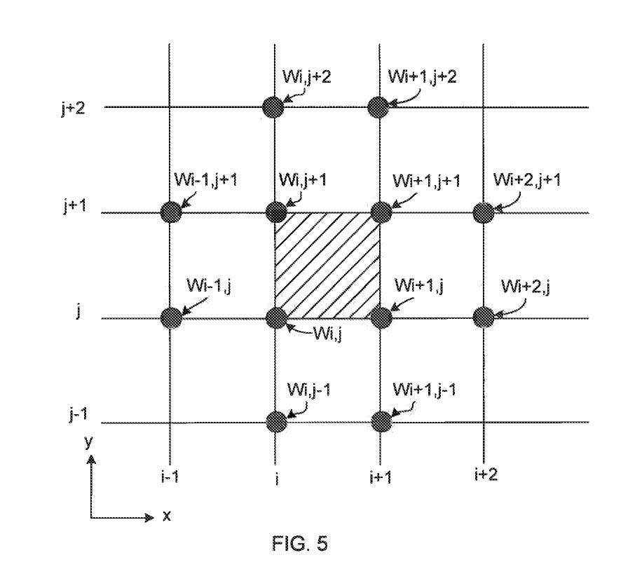

Now the subscripts for u and v can be dropped without ambiguity. The terms in Equation (14) contain only pixel values, u, v, and functions of u and v. Any interpolated value is just a weighted sum of the twelve nearest pixels. These pixels are illustrated in FIG. 5. It can be rewritten to show this explicitly.

$$Q ( x , Y ) = {w}_{i , j} ( u , v ) \cdot {z}_{i , j} + {w}_{i - 1 , j} ( u , v ) \cdot {z}_{i - 1 , j} + {w}_{i , j - 1} ( u , v ) \cdot {z}_{i , j - 1} + {w}_{i + 1 , j} ( u , v ) \cdot {z}_{i + 1 , j} + {w}_{i , j + 1} ( u , v ) \cdot {z}_{i , j + 1} + {w}_{i + 1 , j - 1} ( u , v ) \cdot {z}_{i + 1 , j - 1} + {w}_{i - 1 , j + 1} ( u , v ) \cdot {z}_{i - 1 , j + 1} + {w}_{i + 2 , j} ( u , v ) \cdot {z}_{i + 2 , j} + {w}_{i , j + 2} ( u , v ) \cdot {z}_{i , j + 2} + {w}_{i + 2 , j + 1} ( u , v ) \cdot {z}_{i + 2 , j + 1} + {w}_{i + 1 , j + 2} ( u , v ) \cdot {z}_{i + 1 , j + 2} + {w}_{i + 1 , j + 1} ( u , v ) \cdot {z}_{i + 1 , j + 1}$$

### Where:

$${w}_{i , j} ( u , v ) = {cos}^{2} ( \frac{π u}{2} ) \cdot {cos}^{2} ( \frac{π v}{2} ) \cdot ( 1 - {u}^{2} - {v}^{2} + uv ) + {sin}^{2} ( \frac{π u}{2} ) \cdot {cos}^{2} ( \frac{π v}{2} ) \cdot ( 2 + 2 uv - 2 v - 3 u + {u}^{2} ) / 2 + {cos}^{2} ( \frac{π u}{2} ) \cdot {sin}^{2} ( \frac{π v}{2} ) \cdot ( 2 + 2 uv - 2 u - 3 v + {v}^{2} ) / 2 + {sin}^{2} ( \frac{π u}{2} ) \cdot {sin}^{2} ( \frac{π v}{2} ) \cdot ( uv - u - v + 1 )$$

$${w}_{i - 1 , j} ( u , v ) = {cos}^{2} ( \frac{π u}{2} ) \cdot {cos}^{2} ( \frac{π v}{2} ) \cdot ( - u + {u}^{2} ) / 2$$

$${w}_{i , j - 1} ( u , v ) = {cos}^{2} ( \frac{π u}{2} ) \cdot {cos}^{2} ( \frac{π v}{2} ) \cdot ( - v + {v}^{2} ) / 2$$

$${w}_{i + 1 , j} ( u , v ) = {cos}^{2} ( \frac{π u}{2} ) \cdot {cos}^{2} ( \frac{π v}{2} ) \cdot ( u + {u}^{2} - 2 uv ) / 2 + {sin}^{2} ( \frac{π u }{2} ) \cdot {cos}^{2} ( \frac{π v}{2} ) \cdot ( 2 u - {u}^{2} - uv + v - {v}^{2} ) + {cos}^{2} ( \frac{π u}{2} ) \cdot {sin}^{2} ( \frac{π v}{2} ) \cdot ( u - uv ) + {sin}^{2} ( \frac{π u}{2} ) \cdot {sin}^{2} ( \frac{π v}{2} ) \cdot ( - 2 uv + 2 u - v + {v}^{2} ) / 2$$

$${w}_{i , j + 1} ( u , v ) = {cos}^{2} ( \frac{π u}{2} ) \cdot {cos}^{2} ( \frac{π v}{2} ) \cdot ( v + {v}^{2} - 2 uv ) / 2 + {sin}^{2} ( \frac{π u}{2} ) \cdot {cos}^{2} ( \frac{π v}{2} ) \cdot ( v - uv ) + {cos}^{2} ( \frac{π u}{2} ) \cdot {sin}^{2} ( \frac{π v}{2} ) \cdot ( 2 v - {v}^{2} - uv + u - {u}^{2} ) + {sin}^{2} ( \frac{π u}{2} ) \cdot {sin}^{2} ( \frac{π v}{2} ) \cdot ( - 2 uv + 2 v - u + {u}^{2} ) / 2$$

$${w}_{i + 1 , j - 1} ( u , v ) = {sin}^{2} ( \frac{π u}{2} ) \cdot {cos}^{2} ( \frac{π v}{2} ) \cdot ( - v + {v}^{2} ) / 2$$

$${w}_{i - 1 , j + 1} ( u , v ) = {cos}^{2} ( \frac{π u}{2} ) \cdot {sin}^{2} ( \frac{π v}{2} ) \cdot ( - u + {u}^{2} ) / 2$$

$${w}_{i + 2 , j} ( u , v ) = {sin}^{2} ( \frac{π u}{2} ) \cdot {cos}^{2} ( \frac{π v}{2} ) \cdot ( - u + {u}^{2} ) / 2$$

$${w}_{i , j + 2} ( u , v ) = {cos}^{2} ( \frac{π u}{2} ) \cdot {sin}^{2} ( \frac{π v}{2} ) \cdot ( - v + {v}^{2} ) / 2$$

$${w}_{i + 2 , j + 1} ( u , v ) = {sin}^{2} ( \frac{π u}{2} ) \cdot {sin}^{2} ( \frac{π v}{2} ) \cdot ( - u + {u}^{2} ) / 2$$

$${w}_{i + 1 , j + 2} ( u , v ) = {sin}^{2} ( \frac{π u}{2} ) \cdot {sin}^{2} ( \frac{π v}{2} ) \cdot ( - v + {v}^{2} ) / 2$$

$${w}_{i + 1 , j + 1} ( u , v ) = {cos}^{2} ( \frac{π u}{2} ) \cdot {cos}^{2} ( \frac{π v}{2} ) \cdot ( uv ) + {sin}^{2} ( \frac{π u}{2} ) \cdot {cos}^{2} ( \frac{π v}{2} ) \cdot ( 2 uv - v + {v}^{2} ) / 2 + {cos}^{2} ( \frac{π u}{2} ) \cdot {sin}^{2} ( \frac{π v}{2} ) \cdot ( 2 uv - u + {u}^{2} ) / 2 + {sin}^{2} ( \frac{π u}{2} ) \cdot {sin}^{2} ( \frac{π v}{2} ) \cdot ( uv + u - {u}^{2} + v - {v}^{2} )$$

The weighting coefficients are functions only of u and v, so their values are identical for all interpolated points at the same relative positions within the area bounded by the centers of four pixels. This considerably simplifies the calculation, since the set of weights for any upsampling can be computed once for an entire image Q(x,y) then a function that defines a point function image at all points and is nearly continuous through the second derivative. It can be used to present the image at any desired upsampling. It does not, of course, recover the information at the higher spatial frequencies that was destroyed by the averaging of the original sensor, but does use the knowledge that a pixel value is an average to construct the point function image, which is consistent with the averages represented by the pixel values. This improves the determination of image registration to subpixel accuracy and should also improve the recognition of objects in the image, which are only a few pixels in dimension.

For some cases, the calculation is very easy. For instance, to upsample by a factor of two, three additional points must be calculated for each original point. They are calculated at the (u,v) pairs, (1/2, 0), (0, 1/2), and (1/2 , 1/2). For the first pair, there are only four non-zero weighting factors, w_{i-1,j}=w_{i+2,j}=− 1/16, and w_{i,j}=w_{i+1,j}= 9/16. The same is true for the second pair, and w_{i,j-1}=wᵢ₊ⱼ₊₂=− 1/16, w_{i,j}=w_{i,j+1}=9/16 . For the third pair, all twelve weighting factors are non-zero, w_{i,j}=w_{i+1,j}=wᵢ₋ⱼ₊₁=w_{i+1,j+1}=5/16 , and w_{i-1,j}=w_{i,j-1}=w_{i+1,j-1}=w_{i-1,j+1}=w_{i+1,j-1}=w_{i+2,j+2}=w_{i+2,j+1}=w_{i+1, j+2=-}1/32. Note that, as is necessary, the sum of the weighting coefficients equals one. This can be shown analytically by summing the expressions for all twelve weighting coefficients.

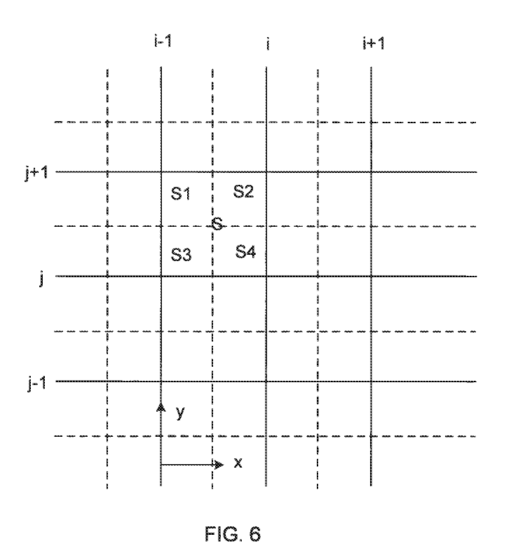

FIG. 6 illustrates the result of the upsampling of the image of FIG. 2. As shown by the dashed lines in FIG. 6, the original subject pixel ‘S’ has been divided in to four sun-pixels S1-S4. In the present embodiment, the combined intensity values of the sub-pixels S1-S4 are equal to the measured intensity value of the subject pixel S.

### Other Applications

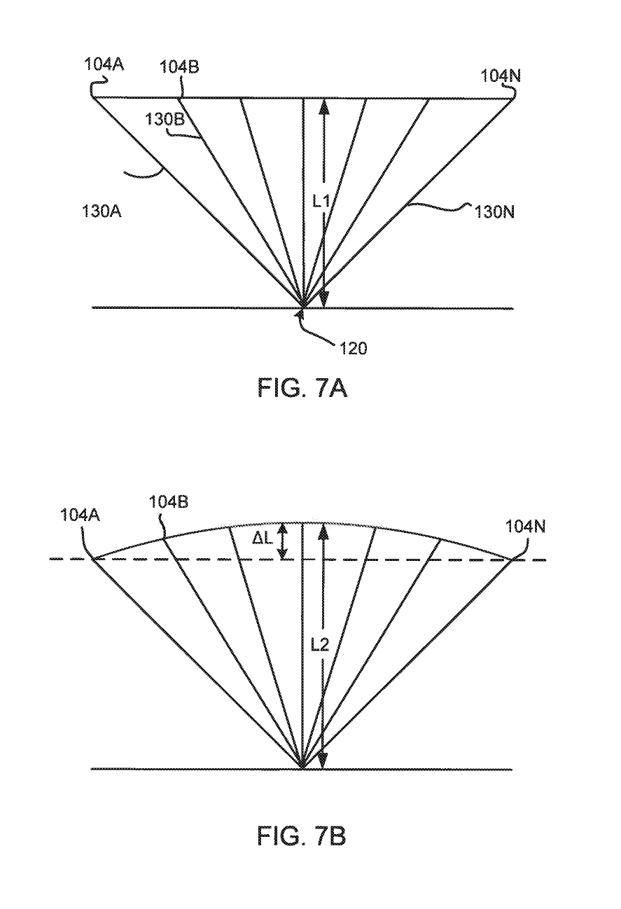

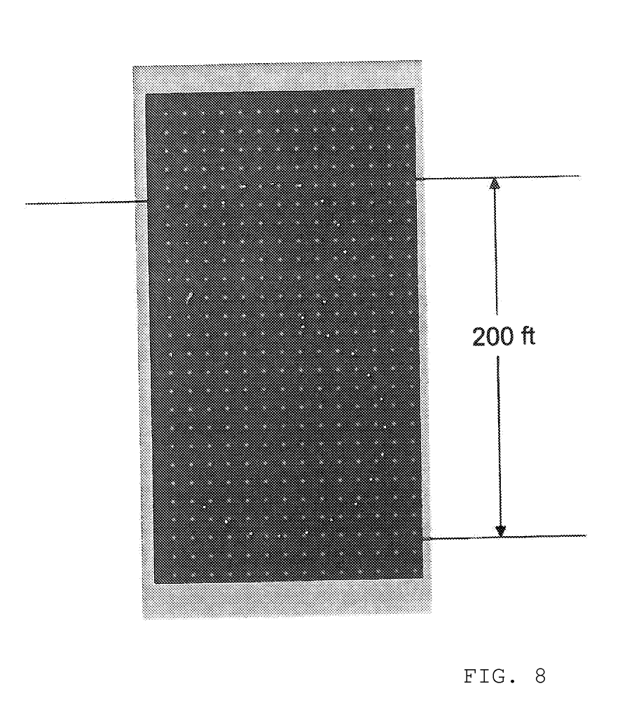

Another application where it is desirable to maintain at least partial second derivative continuity in image interpolation is seismic imaging. Maintaining such second derivative continuity allows for identifying a direction and focus of a wave in seismic imaging. As will be appreciated, in seismic imaging a subterranean area of interest is typically imaged utilizing active or passive seismic sources, which generate sonic/acoustic energy, which is reflected from subterranean events of interest. Seismic energy may be recorded by geophones and/or hydrophones arranged in an array. See FIG. 7A. The signals received at each geophone 104a-n define a trace of seismic data. Each such trace may include a number of features or peaks (also known as reflections and wavelets) corresponding to a number of subterranean reflectors or events. Due to the lateral offsets of the geophones in the array, the timeframe of the different traces for each geophone varies. Accordingly, these timeframes may be adjusted (e.g., normalized/corrected), and the adjusted traces may be stacked to yield data having a higher signal-to-noise ratio. This may allow for better identification of subterranean events.

One problem that is encountered in normalizing/correcting the traces of each geophone is that the individual traces of the geophones may need to be temporally offset at a time that falls between sample values of a particular geophone. Accordingly, it is necessary to interpolate between samples in order to identify data for use in the stack. As will be appreciated, the data acquisition modules or geophories 104 of the array 100 may function to record seismic/acoustic energy at synchronized starting and stopping times. However, due to the travel paths between the point of interest 120 and each individual module being different, the temporal location of the data associated with the point of interest 120 in each seismic trace may be different. Accordingly, in order to stack the multiple traces together in order to improve the signal-to-noise ratio and thereby generate impedance information associated with the point of interest, the data associated with the point of interest in each of the traces of each of the individual modules must be temporally aligned.

In order to align the arrival times of the acoustic/seismic energy from the point of interest in different traces, seismic imaging techniques may delay individual traces of the modules within the array 100. Determining the length L1 of each individual ray 130A-130N and adjusting the length of each ray 130A-130N to place each module at a common theoretical distance L2 from the point of interest 120 generate these delays. See FIGS. 7A and 7B. The difference between adjusted length L₂ and the original length L₁ (i.e., ΔL) is determined for each ray. An estimated average velocity for the acoustic/seismic energy then divides this difference. Accordingly, the result of this calculation is the time delay that is applied to each individual trace. Once adjusted by their individual delays, these traces may be stacked to provide information for the point of interest. Prior to such stacking, additional processing can be performed to make velocity adjustments for each ray through an iterative process of signal sharpening.

However, it will be appreciated that delaying the individual traces may result in miss-matches of the sampled data. For instance, each individual module 104 may sample seismic data at a predetermined rate (e.g., every two milliseconds). Accordingly, delaying any trace at a non-integer multiple of two milliseconds results in moving the trace to a time where there is no recorded data. Accordingly, it becomes necessary to interpolate the data for the adjusted time. It has been determined that simple linear interpolation between adjacent samples fails to provide an adequate data sample for the adjusted time trace. Accordingly, the quasi-quadratic interpolation process discussed above is utilized for the interpolation. Conventional prior practice uses some technique of polynomial interpolation such as Gaussian, which maintains only the function continuity. Fairly complex spline techniques have been used to provide first and second derivative continuity for one-dimensional interpolation. The quasi-quadratic interpolation technique provided herein provides second derivative continuity and can easily be applied for an arbitrary number of dimensions.

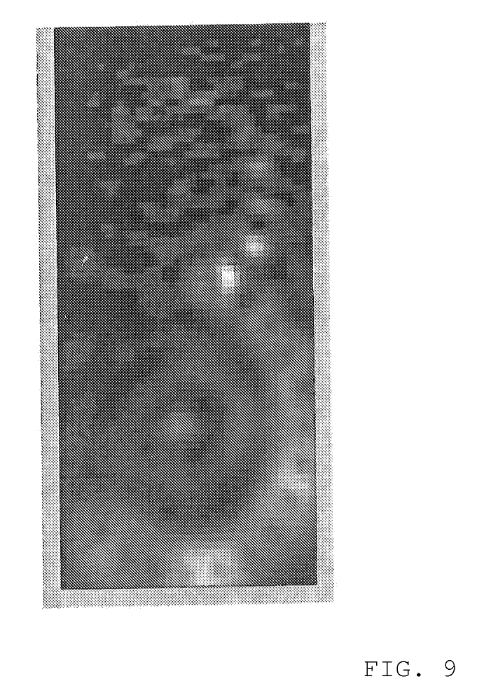

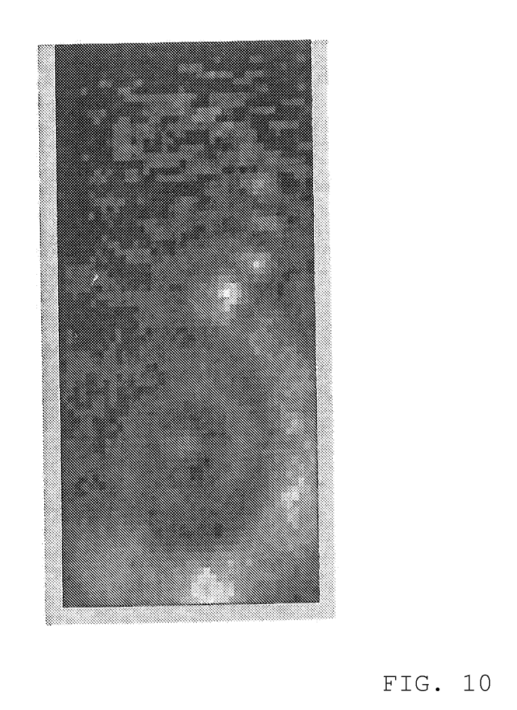

In order to test the quasi-quadratic interpolation process discussed above using seismic data, test data was utilized wherein a sensor array having an array with a diameter of 10,500 feet and including 1,000 sensors was modeled. A depth of the focus plane was set at 10,000 feet. A source within the focus plane had a dimension of 200 feet. The source, as shown in FIG. 8 is represented by a ‘FIG. 3”. As shown, an emitter was placed in the source every 15 degrees on the large circle and every 22½ degrees on the small circle. For convenience, the center of the array was positioned at the center of the three. The array spacing was set at 30 feet such that 612 pixels (18×34) or focal points used to create an image. A first image was formed with 100 hertz, 2 millisecond sampling and quasi-quadratic interpolation at 10,000 feet depth with an array of 10,500 feet diameter. A sound velocity of 5,000 feet per seconds was utilized. As shown, the seismic sampling allowed for generating an image (see FIG. 9) of the source using the trace signals generated by the surface geophones. Additionally, the same process was performed utilizing a non-quasi-quadratic interpolation scheme. This is illustrated in FIG. 10. As can be seen, the subterranean image generated utilizing quasi-quadratic processing is considerably clearer than that produced without such processing.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. An interpolation method for digital images, comprising:
obtaining a pixel image including a plurality of pixels;
calculating four quadratic surfaces at the corners of an area defined by four of said pixels;
generating a quasi-quadratic surface for the area using said four quadratic surfaces; and
using said quasi-quadratic surface to determine an interpolated value for a point within said area; and
using said interpolated value to generate an interpolated pixel image.

2. The method of claim 1, wherein obtaining said digital image further comprises:
converting values of said pixels to point values located at the center of said pixels.

3. The method of claim 2, wherein said area is defined by four point values of said pixels.

4. The method of claim 2, wherein converting values of said pixels comprises for each said pixel:
utilizing four adjacent pixels to a subject pixel to estimate a two dimensional quadratic representation over the area of the subject pixel; and
integrating the quadratic representation over the area of the subject pixel to obtain a correction formula for said subject pixel.

5. The method of claim 4, wherein the integral of the quadratic representation over the area of the subject pixel is equal to a measured value of said subject pixel.

6. The method of claim 1, wherein said four pixels define corners of said area.

7. The method of claim 6, wherein each said four quadratic surfaces is calculated from a pixel set including said four pixels.

8. The method of claim 7, wherein the second derivative of each of said four quadratic surfaces are continuous at said four pixels.

9. The method of claim 1, wherein said quasi-quadratic surface is defined as a weighted sum of twelve pixels surrounding said area.

10. The method of claim 9, wherein using said interpolated value further comprises:
calculating sub-pixel values for said area.

11. The method of claim 10, wherein a combined value of said sub-pixel values is equal to a measured value for said area.

12. An interpolation method for digital images, comprising:
obtaining a pixel image including a plurality of pixels having measured values;
computing a point value pixel image having point values at the center of each of said plurality of pixels;
calculating four quadratic surfaces centered on the corners of an area defined by four of said point values;
generating a surface for the area using said four quadratic surfaces, wherein said surface is a function of said point values;
using said surface to determine an interpolated value for a point within said area; and generating an interpolated pixel image using said interpolated value.

13. The method of claim 12, wherein said point values are equal to said measured values for each of said plurality of pixels.

14. The method of claim 12

15. The method of claim 12, wherein each said four quadratic surfaces is calculated from a pixel set including said four pixels.

16. The method of claim 12, wherein the second derivative of each of said four quadratic surfaces are continuous at said corners.

17. The method of claim 12, wherein said surface is defined as a weighted sum of twelve pixels surrounding said area.

18. The method of claim 12, wherein generating said interpolated pixel image further comprises:
calculating sub-pixel values for said area.

19. The method of claim 18, wherein a combined value of said sub-pixel values is equal to a measured value for said area.

20. An interpolation method for digital images, comprising:
obtaining a pixel image including a plurality of measures pixel values for each pixel area of said pixel image;
for a subject pixel area, utilizing four neighboring pixel values to the subject pixel area to estimate a quadratic representation over the subject pixel area; and
integrating the quadratic representation over the subject pixel area to obtain a correction formula for said subject pixel value, wherein the integration of the quadratic representation over the subject pixel area is equal to a measured value of said subject pixel; and
utilizing said correction formula to calculate a point value for said subject pixel centered at a center of said subject pixel.

21. The method of claim 20, wherein point values are calculated for each pixel area of said image to produce a point value image.

22. The method of claim 20, wherein utilizing four neighboring pixel values further comprises:
utilizing a first set of pixel values along a first axis to define a first quadratic function for said area; and
utilizing a second set of pixel values along a second axis to define a second quadratic function for said area.

23. The method of claim 22, wherein said first and second quadratic functions are centered at said center of said subject pixel.
